(19) United States
(12) Patent Application Publication
(10) Pub. No.: US 2005/0019453 A1
(43) Pub. Date: Jan. 27, 2005

(54) Edible novelty products

(75) Inventor: Daniel D. Witkowski, Minneapolis, MN (US)

Correspondence Address: MUETING, RAASCH & GEBHARDT, P.A., P.O. BOX 581415, MINNEAPOLIS, MN, 55458, US

(73) Assignee: MagicCom, Inc., Minneapolis, MN (US)

(21) Appl. No.: 10/864,907

(22) Filed: Jun. 9, 2004

Related U.S. Application Data
(60) Provisional application No. 60/477,157, filed on Jun. 9, 2003.

(51) Int. Cl. C12C 1/027

(52) U.S. Cl. 426/106

(57) ABSTRACT

The present invention, in various embodiments, may combines a toy, and/or a game of skill, and/or chance, and/or a craft activity, and/or a novelty entertainment or amusement, or any combination thereof with food or consumable product. The edible novelty products of the invention may include, e.g., linking articles, puzzle pieces, words, gas-producing compositions, etc. The edible novelty products of the present invention may preferably include a container for the edible articles. The container may be in the form of a can, bottle, pouch, bag, box, etc. The container may preferably be sealed to retain product freshness, etc. until use.

### RELATED APPLICATIONS

The present application claims the benefit of U.S. Provisional Application No. 60/477,157 titled EDIBLE NOVELTY ITEMS AND METHODS OF USING AND MAKING THE SAME, filed Jun. 9, 2003, which is hereby incorporated by reference in its entirety.

For years parents have told their children not to play with their food. Daycare providers, teachers, and society have reinforced this taboo. Yet children do not look at the consumption of food as merely a way to satisfy hunger. Food, like most things in a child's world, is something to inspire imagination and provide entertainment in addition to providing nourishment and creating a feeling of fullness and satisfaction.

Marketers have tried to make food appealing to children in numerous ways with flavors, colors, ease of preparation and delivering food in various varieties, packages, shapes and forms. For example, both alphabet soup and alphabet cereal with ABC-shaped pieces have attempted to make food interactive. However, children view shapes such as these as an educational tool or teaching experience that is more reminiscent of school and homework, and not considered to have true play value in a child's world.

Other examples are shaped cookies that children cut and decorate with frosting during the holiday season. While there is some entertainment value in “the process” of making the cookies, there is no interactive or play value with the cookies once they are baked, and these cookies often go uneaten because of the fear that a child's sanitary habits relating to food preparation are not usually in keeping with accepted health practices.

Other examples are various food and beverage products that have been created to change color by introducing edible fruit or vegetable dyes into their composition. However, the mere act of changing the color of a food product is not considered playful or novel by itself since the outcome is always predictable, and there is no element of surprise, or unanticipated change. Because the product outcome lacks novelty, it provides no sustained amusement that typically results with an unpredictable outcome, which is the basis of most classic toys or games.

Other recent examples in the marketplace include products such as ketchup, bottled margarine, yogurt, ice cream and the like that have added colorants to change traditional colors of their products to make them more appealing to kids. Unfortunately, these attempts to add interest to traditional food products have failed in the marketplace. New colors alone do not create a new opportunity or experience for children to truly play or interact with the product and receive sustained entertainment value as one would expect when a child interacts with a favorite toy or plays a favorite game.

Cereal, snack, beverage and other food companies have long tried to add fun and play value to their products by inserting premiums such as rings, plastic toys, booklets, comics, stickers, tattoos and the like as value-added components in their boxes, on labels, or in packaging to entice children and/or adults to purchase the product. However, these “premiums” do little to enhance the actual experience of consuming the cereal, snack, or beverage itself, but rather, they are stand-alone items usually made or paper, plastic or similar non-consumable materials and are not part of the food product itself. In addition to the added cost of producing these premiums, these products are usually required to be packaged in an over-wrap material to act as a barrier between the toy or novelty and the food itself to prevent odor, chemical or color migration to the food or consumable product in which they are packaged. Such a barrier is required to prevent the inks, pigments, plastic resins, and similar materials from having direct food contact so as not to transfer odors and chemicals to the food products. Barriers are also required to make sure the toy or premium is not mixed with the food or consumable so as to create a choking hazard or other safety hazard. These premiums, and the related over-wrap barriers, plus insertion and related marketing costs increase the costs to the food manufacturer as well as to the consumer.

Another marketing tactic that has been used by manufacturers of cereal, fruit snacks, meats, crackers, cookies, canned and dry pasta, candy, frozen or non-frozen confections, and many other consumable products to add interest to their products has been to produce food in die cut, extruded or molded shapes of popular cartoon characters, animals, unusual shapes, icons and the like. Unfortunately, except for the visual benefits of seeing these shapes for the first time, these shapes do not provide the consumer with an opportunity to interact with the product in terms of creating a play experience, a craft activity, or suggesting a game of skill or chance. Traditionally shaped crackers, cookies and the like are merely shapes, and not considered by children to be a toy or game or having no true entertainment or play value.

Popcorn may be considered the ultimate fun food since it provides a natural variety in the sound of the popping, and the kernel's transformation from a hard yellow substance to large white fluffy materials four times the size of the original kernel. However, the intense boiling oil or high temperature of the stove, microwave or air popper required to make popcorn makes it unsuitable for children to actively participate in the cooking/transformation process.

Toys and game have been staples of early childhood development for centuries. They assist children in developing motor skills, stimulating imagination, developing conceptual and reasoning skills. Virtually any popular toy has a key element of versatility that allows a child to have a different “play experience” every time the child picks up the toy. Toys such as building blocks, crayons, dolls, molding clay, construction sets, board games, puppets, balls, memory games, skill games, chance games, crafts and the like allow a new or slightly different experience which is what intrigues stimulates and entertains a young mind.

Many popular toys, games and novelties of the past are no longer part of contemporary society as they were made out of materials, or were of such a size or composition, that they present a serious safety hazard to children. Many toys or games have been banned or discontinued since various toy or game parts present choking hazards, puncture hazards, or feature sharp or serrated parts that could cut skin or eyes, are made of materials that present burning and/or fire hazards, are made of poisonous or toxic materials, have small parts or components that could become lodged in ear or nose canals or other body cavities, contain pieces or materials that can cause vision impairment or possible blindness, can cause allergic reaction and many other potentially dangerous hazards. Since the 1960's many governments have enacted laws that establish strong safety standards for traditional toys, games, novelties and entertainments especially geared for children. These laws have resulted in many traditional toys being eliminated from the market because they are not considered safe due to size, materials, or dangers that they can present.

### SUMMARY OF THE INVENTION

The present invention, in various embodiments, may combines a toy, and/or a game of skill, and/or chance, and/or a craft activity, and/or a novelty entertainment or amusement, or any combination thereof with food or consumable product. The edible novelty products of the invention may include, e.g., linking articles, puzzle pieces, words, gas-producing compositions, etc.

The edible novelty products of the present invention may preferably include a container for the edible articles. The container may be in the form of a can, bottle, pouch, bag, box, etc. The container may preferably be sealed to retain product freshness, etc. until use.

The edible novelty products may take the form of pretzels, noodles, crackers, cookies, etc. that may be used for entertainment before or during consumption. In all embodiments of the invention, the edible articles may be, but are not necessarily, located within a soup broth, sauce (e.g., cheese, tomato, etc.), a beverage (e.g., hot cocoa, lemonade, etc.), or other liquid. In some instances, the package containing the articles may include a dried powder that, when reconstituted with water (or an aqueous solution) forms a soup broth, sauce, beverage, or other liquid in which the edible articles are located. Reconstitution of the dried powder may also hydrate the edible articles in the container if, e.g., they are provided as noodles, marshmallow products, etc. It may be preferred that the edible articles be provided in the form of hydrated articles that are softened such that they pose a reduced risk of choking when consumed.

Potential advantages of the present invention may include satisfying a child's (or adult's) instinctive desire to play or interact with food or other consumable products, yet allows them to do so in a manner that is safe and in compliance with regulations and safety laws and guidelines relating to small parts, choking hazards, and the like. The inherent dangers that are present in most small toy game or craft parts manufactured with traditional materials such as plastic, fabric, paper and similar materials may be reduced by making said pieces of food product compositions that are digestible and/or that are softened as eaten (e.g., cooked noodles).

Other potential benefits of the invention include stimulating imaginations, driving competitiveness, encouraging creative thinking and enhancing skill building as consumers interact and play with these products while they are eaten or consumed.

Another potential benefit of the invention is that because the materials used to manufacture the edible novelty products of this invention are preferably constructed of relatively low-cost food or consumable materials, the consumer has the added value of food that acts as entertainment for relatively the same price that they have paid for a food-only product in the past. This may provide a significant marketing advantage for a manufacturer of soup or cereal (for example) over a competitor. By utilizing this invention, a food manufacturer would be able to offer consumers a free game, toy or craft activity with each purchase of the food product while, for the same price, a competitor would only be able to offer a mere food product alone.

Yet another potential benefit of the present invention is that a similar play experience of a comparable traditional toy or game can be offered to consumers at a much lower cost. This is due to the high volume and comparatively low cost of manufacturing food products in comparison to the relatively low volume and high cost of manufacturing and selling toys and games.

The edible novelty products of the present invention may preferably be manufactured using known technologies for creating shaped, stamped, embossed, debossed colored and/or decorated pieces including traditional forms of die cutting, extruding, stamping, molding and manufacturing and packaging food and consumable products.

Food materials that may be adapted or used to manufacture digestible or consumable interactive toy, craft or game components of the invention include most food or beverage products including cereals, soups, pasta, noodles, crackers, cookies, cakes, snacks, salty snacks, sweets, candy, confections, breads, grains, fruits, vegetables, milk, dairy products, cheese, cheese foods, meats, fish, poultry, nuts, seeds, beans, frozen foods, jams, jellies, preserves, meal kits, canned pasta, packaged pasta, bakery products, fried products, grains, chili, stews, hash, tacos, burritos, wraps, sandwiches, ice cream and frozen novelties, pretzels, chips, popcorn, fruit snacks, gelatins, puddings, shelf-stable meals, canned products, products sold in boxes or pouches, wrappers, bulk or in containers, carbonated or non-carbonated beverages, hamburgers, hot dogs, fries, pizza, mixes, add-in's, supplements, vitamins, deli items, salads, seasonings, toppings, frosting, sprinkles, fruit snacks, candy bars, snack items and the like. When adapted to the invention, these products provide the formulas and recipes that allow the invention to have interactive play or entertainment value as well as provide nourishment and eliminate most safety concerns relating to small parts.

In one aspect, the present invention provides an edible novelty product that includes a container and a plurality of identical linking articles located within the container, wherein each linking article of the plurality of identical linking articles has a linking feature such that three or more of the linking articles can be attached to each other and suspended by grasping only one of the three or more linking articles, wherein the linking articles are constructed of food product material, and wherein the linking articles have shapes that are not alphabetical characters.

In another aspect, the present invention provides an edible novelty product that includes a container and a plurality of edible puzzle pieces located within the container, wherein each puzzle piece of the plurality of puzzle pieces includes at least one of a male linking feature or a female linking feature such that at least two of the puzzle pieces can be attached to each other using one male linking feature and a complementary female linking feature to form an animal-like shape, wherein the puzzle pieces are constructed of food product material.

In another aspect, the present invention provides an edible novelty product that includes a container and a plurality of edible novelty articles located within the container, wherein the edible novelty articles are constructed of food product material, and wherein each edible novelty article of the plurality of edible novelty articles is in a word shape.

In another aspect, the present invention provides an edible novelty product that includes a container and a plurality of edible novelty articles located within the container, wherein the edible novelty articles are constructed of food product material, and wherein each edible novelty article of the plurality of edible novelty articles includes indicia in the form of a word located on a surface of the edible novelty article.

In another aspect, the present invention provides an edible novelty product that includes an edible body having a cavity formed therein, wherein the edible body is constructed of food product material; a gas producing edible composition located in the cavity, wherein the gas producing edible composition produces a gas when contacted with an aqueous solution.

In another aspect, the present invention may take the form of a soup or beverage containing edible articles in shapes that allow the consumer to play a game or engage in an activity other than eating while consuming the soup or beverage.

These and other features and advantages of the present invention may be described below in connection with various exemplary embodiments of the present invention.

### BREIF DESCRIPTIONS OF THE FIGURES

FIG. 1 depicts one exemplary embodiment of an edible novelty product including linking articles.

FIG. 2 depicts another exemplary embodiment of an edible novelty product including linking articles.

FIG. 3 depicts another exemplary embodiment of an edible novelty product including linking articles.

FIG. 4 depicts another exemplary embodiment of an edible novelty product including edible novelty articles in the shape of words.

FIG. 5 depicts another exemplary embodiment of an edible novelty product including edible novelty articles with indicia in the form of words.

FIG. 6 depicts another exemplary embodiment of an edible novelty product including edible novelty articles in the form of an edible body comprising a cavity formed therein.

FIG. 7 is a cross-sectional view of one edible body with a cavity formed therein.

FIG. 8 depicts an edible novelty product that includes a plurality of anatomical features.

FIG. 9 depicts an edible novelty product that includes a plurality of edible articles in the shapes of sports figures.

FIG. 10 depicts an edible novelty product that includes a plurality of edible articles that resemble a rock, paper, and scissors.

FIG. 11 depicts an edible novelty product that includes a plurality of edible articles in the shape of pirates, pirate icons (e.g., skull & crossbones), and a ship.

FIG. 12 depicts an edible novelty product that includes a plurality of edible articles in the shape of football players, goalposts, and footballs.

FIG. 13 depicts an edible novelty product that includes a plurality of edible articles in the shape of clues.

### DESCRIPTION OF EXEMPLARY EMBODIMENTS OF THE INVENTION

In the following detailed description of some exemplary embodiments of the invention, reference is made to the accompanying figures which form a part hereof, and in which are shown, by way of illustration, specific embodiments in which the invention may be practiced. It is to be understood that other embodiments may be utilized and structural changes may be made without departing from the scope of the present invention.

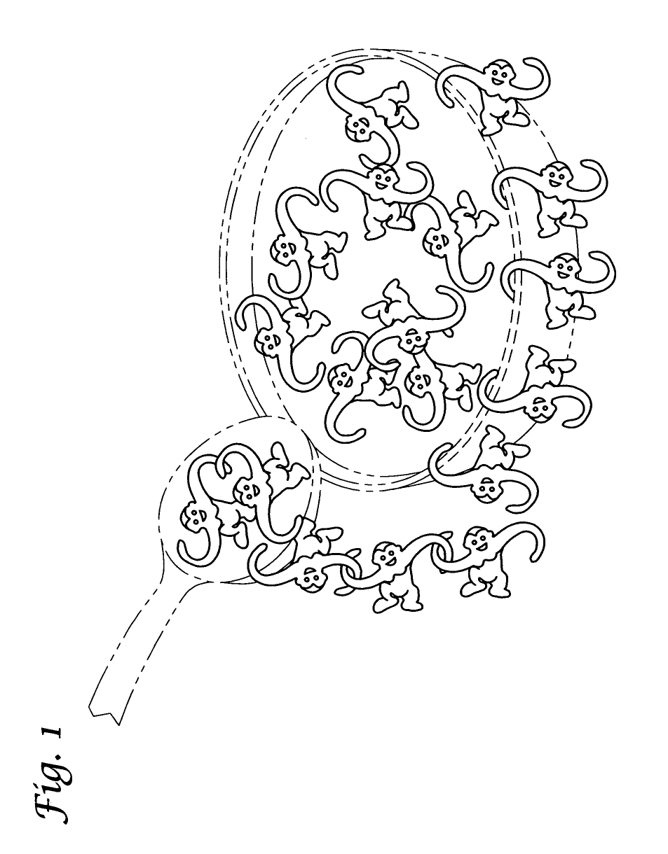

In on embodiment depicted in FIG. 1, the present invention may provide an edible novelty product where linking articles are constructed of food product materials such as, e.g., flour-based products (e.g., pasta, noodles, cereal, salty snacks, pretzels, cookies, etc.), candy, fruits, vegetable pieces, etc. The linking articles 10 may preferably consist essentially of food product materials.

Although not depicted in a container, it may be preferred that the linking articles 10 be provided in a container. At least one group of the linking articles may preferably be identical in shape. It may be preferred that, except for those articles broken or deformed from their intended shape, substantially all of the articles constructed of food product material in the container be linking articles in accordance with the present invention.

The linking articles 10 preferably include a linking feature such that two or three or more of the linking articles 10 can attached to each other and suspended by grasping only one of the linking articles. The linking feature in the linking articles 10 are in the form of hooks 12 extending outward from a central body 14. Although the linking articles 10 are depicted with only two hooks 12, it should be understood that linking articles of the present invention may include three or more hooks. Furthermore, although the depicted hooks 12 are arcuate in shape, it should be understood that the hooks 12 may take any suitable shape, e.g., the hooks 12 may include line segments that are not arcuate.

In the depicted example, the linking articles 10 are monkey-shaped, although other examples of potential linking articles including two or more hooks may include, but are not limited to, elephants, worms, snakes, etc. It may be preferred that the linking articles of the present invention are not in the shape of alphabetical characters.

The edible novelty product may also include instructions directing a consumer to link two or more of the linking articles 10 together to, e.g., form a chain. The object of such a game could be to hook together multiple linking articles 10 to form a long chain.

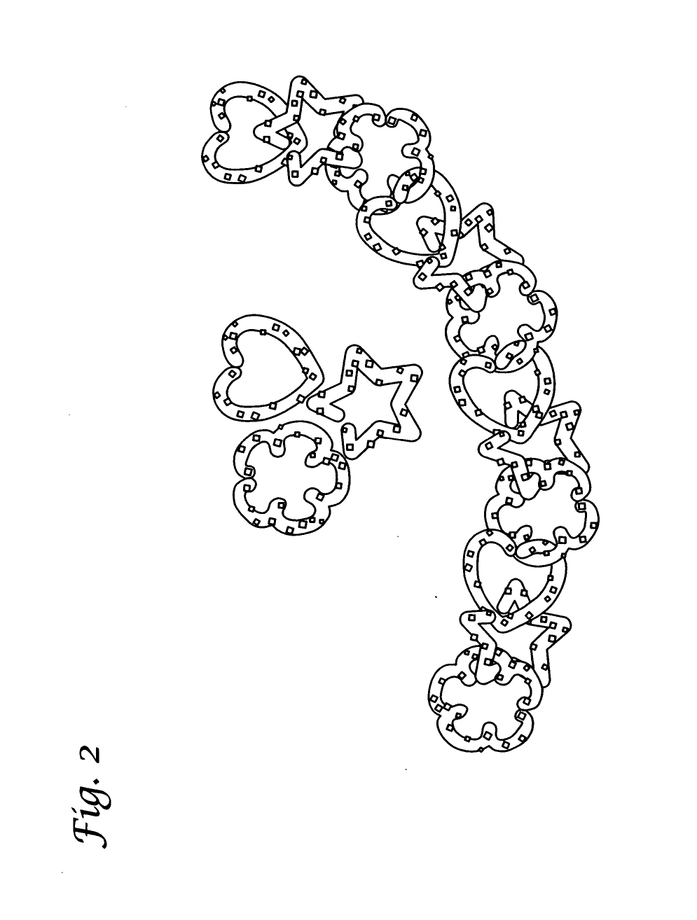

FIG. 2 depicts another exemplary embodiment of an edible novelty product including linking articles 110 in which the linking articles 110 are in the form of line figures formed by food product material. The line figures 110 are constructed of lines 112 having a line width measure generally transverse to the direction of the line. Although the linking articles 110 depicted in FIG. 2 are constructed entirely as line figures, it should be understood that in some instances the linking articles could include a body that is not in the form of a line figure, but that include a line figure extending from the body (for example, the hooks of linking articles 10 could be extend back towards the body 14).

The linking feature in the linking articles 110 is in the form of a gap 114 in the otherwise closed figure formed by the linking article 110. In some instances, it may be preferred that the gap 114 be an opening that is four times or less the line width of the lines 112 of the line figures, more preferably two times or less the line width.

The linking articles 110 may take many different shapes. The shapes depicted in FIG. 2 include geometric figures that are closed except for the gap 114. Such geometric figures may include, but are not limited to, polygons (e.g., rectangles, squares, triangles, etc.), circles, ovals, ellipses, etc. Other shapes for the linking articles may include, e.g., animals, people, characters, hearts, stars, clover leafs, icons, vehicles or other non-descript shapes which allow them to be linked or connected in some form.

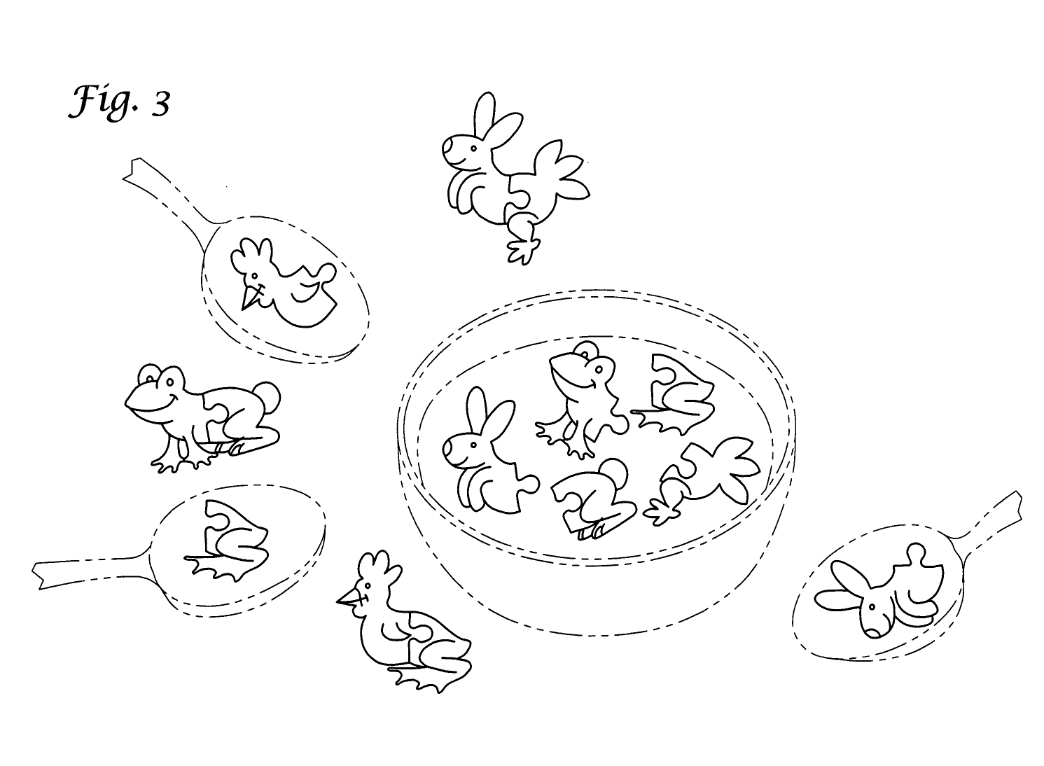

In another exemplary embodiment depicted in FIG. 3, the linking articles 210 may include a linking feature in the form of at least one of an interlocking male feature 212 and an interlocking female feature 214 (similar to, e.g., puzzle pieces). Although the depicted linking articles 210 include only one male feature 212 or female feature 214, it should be understood that each linking article 210 may include two or more of each linking feature and/or combinations of both male and female linking features.

It may be preferred that the linking articles 210 be in the form of a portion f an animal, such that two or more of the linking articles 210 may be connected to form a composite animal 220 using a male linking feature on one linking article 210 and a female linking feature on another linking article 210. The linking articles 210 forming the composite animal 220 may be from the same animal (e.g., frog, rabbit, bird, etc.) or from different animals.

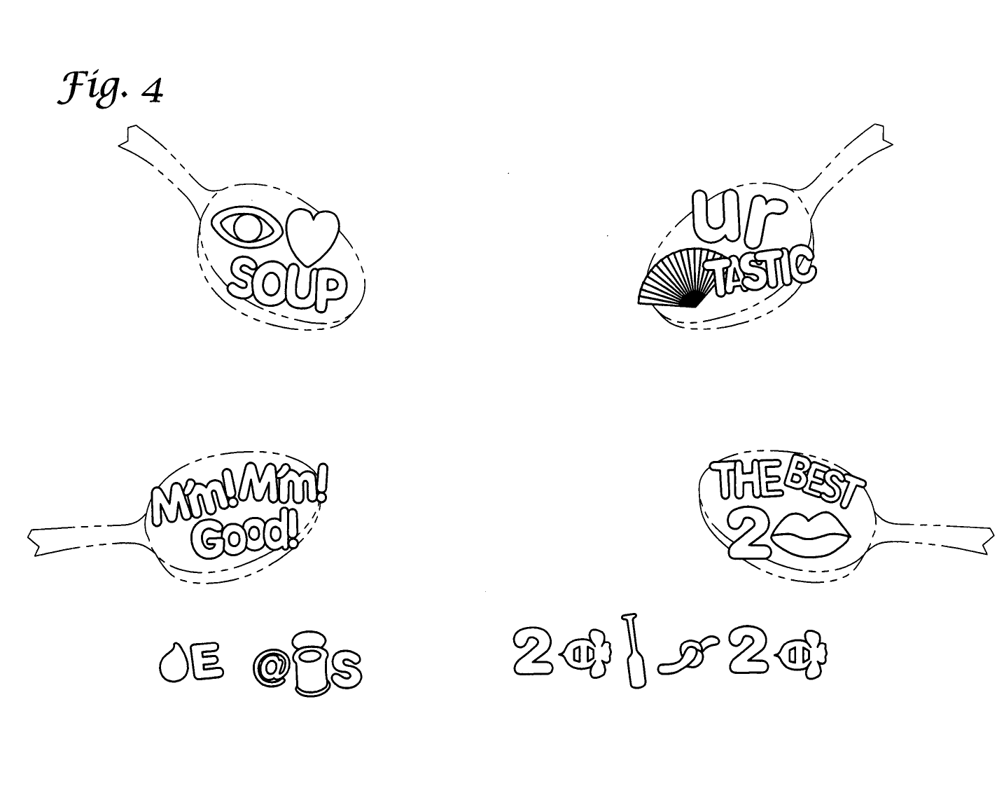

Turning to FIG. 4, another exemplary embodiment of the edible novelty products of the present invention may be in the form of a container including a plurality of edible articles 310 that are in the shape of a word (in any suitable language and alphabet). The container may also include edible articles 220 in the form of single letters and/or icons that may be randomly or intentionally combined with one or more of the word-shaped edible articles 310 to form a rebus, i.e., a combination of objects, icons, letters, words, etc. that suggest a word or a phrase.

The word-shaped edible articles 310 may preferably include a variety of different word shapes, i.e., different words. As used herein, a “word” is a combination of two or more letters from an alphabet (Latin, Cyrillic, Greek, Arabic, etc.). It may be preferred that among the word-shaped edible articles 310, at least one noun and at least one verb be provided in the container. In some instances, the edible articles 310 may include two or more words in a single, unitary edible article 310.

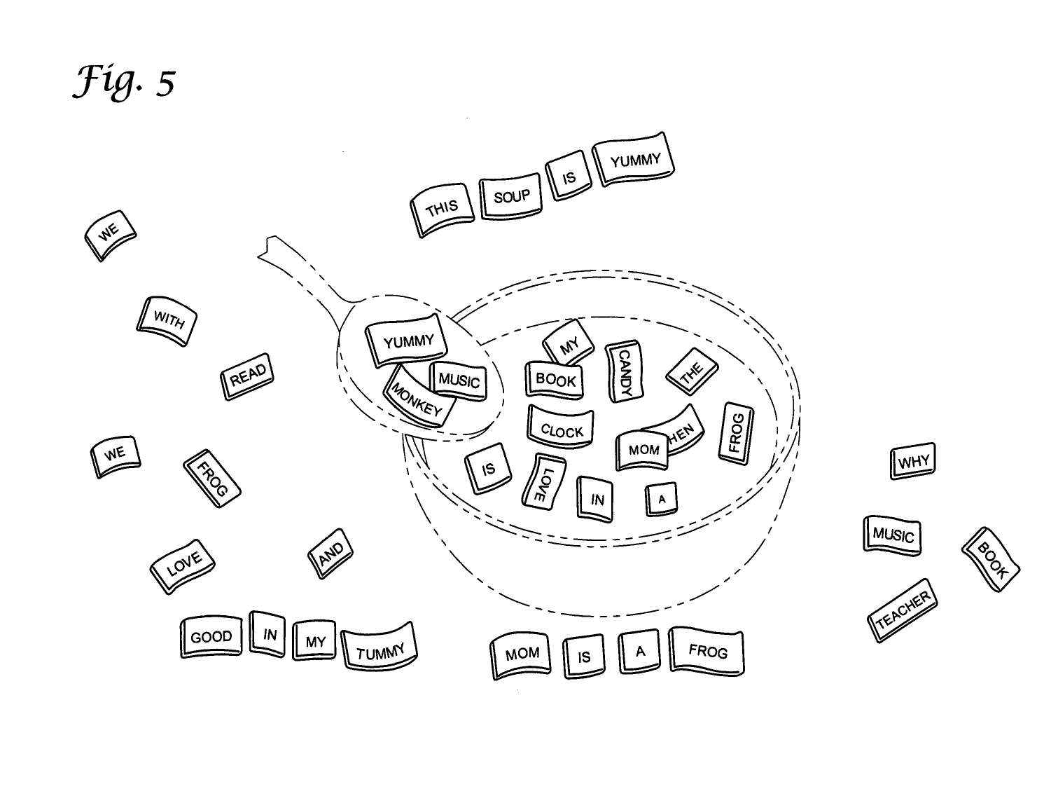

Another exemplary embodiment of the present invention is depicted in FIG. 5 in which edible articles 410 that include indicia in the form of a word on the surface of the edible article 410. The indicia may be printed on the edible article 410 or embossed, molded or otherwise formed in the surface of the edible article 410. It may be preferred, in some instances, that the indicia include two or more words on a single edible article 410. It may be preferred, in some instances, that the indicia on different edible articles 410 form different words. In some cases, the indicia on at least some of the edible articles may preferably include at least one noun and at least one verb.

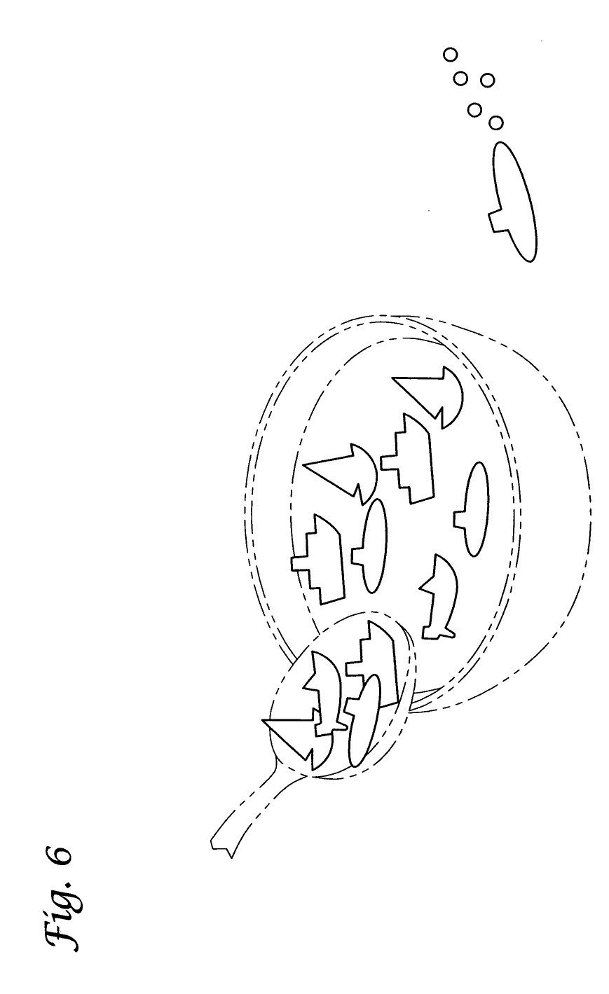

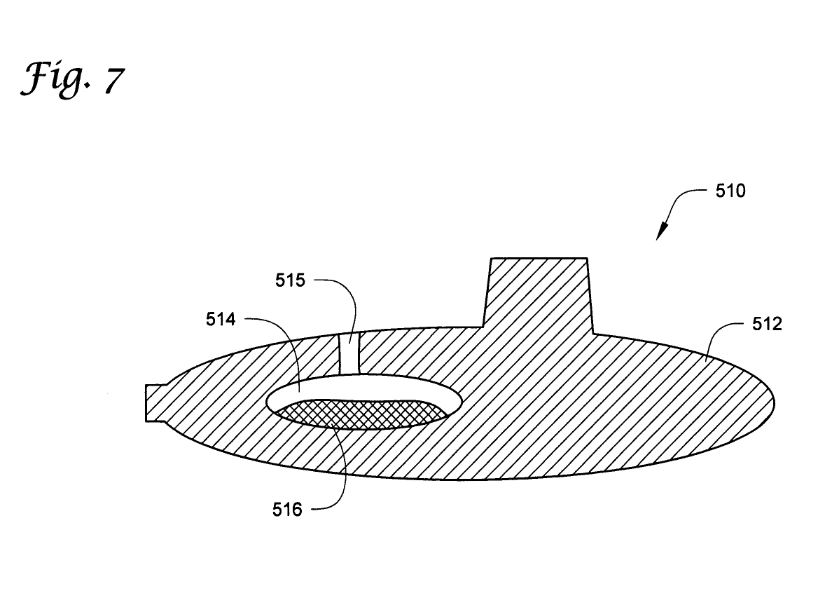

FIG. 6 depicts another exemplary embodiment of an edible novelty product in which an edible article 510 includes an edible body 512. As seen in the cross-sectional view of FIG. 7, the edible body 512 preferably includes at least one cavity 514 that contains a composition 516 that is capable of producing a gas when contact with an aqueous solution or water. The edible body 512, in addition to having a cavity 514, may also preferably have a vent 515 through which the gas can escape. The production of the gas may preferably cause the edible article 510 to move in the aqueous solution (e.g., soup broth, milk, lemonade, etc.) or water.

Although the edible body 512 depicted in FIG. 7 includes only one cavity 514, it will be understood that edible bodies according to the present invention could include more than one cavity and that any or all of the cavities may include a gas-producing edible composition.

The composition 516 is preferably edible such that the edible article 510 can normally be consumed without adverse effects by a child or an adult. One example of a suitable edible composition that could be used to produce a gas is baking powder.

The edible body 512 may preferably be a baked product, e.g., cracker, cookie, pretzel, etc. The edible body 512 may take any desired shape including, but not limited to, marine animal (e.g., fish, shark, whale, seal, octopus, jelly fish, etc.), human, land animal, submarine, boat, airplane, wheeled vehicle (e.g., car, truck, train, etc.).

In still other variation, the present invention may take the form of a soup or beverage containing edible articles in shapes that allow the consumer to play a game while consuming the soup, sauce, beverage, or other liquid in which the edible article are located. The game may preferably involve the selection of one or more shapes on a spoon or other eating utensil. The selection process may be performed randomly, by dipping the eating utensil into the liquid, or it may be intentional, wherein the eating utensil is used to select specific edible articles and/or combinations of edible articles. The edible novelty product of the invention may also include instructions, e.g., on or in the container, that provide guidance, rules, etc. for playing a game associated with the selection of edible novelty articles. In such a game or activity, particular combinations on a given spoonful may result in one or more different outcomes in the game.

In such an embodiment, the edible novelty product may preferably contain edible articles in different shapes and, in some instances, the population distribution of one or more of the shapes may be selected to enhance the entertainment value of the game. For example, in a mystery game, the presence, absence and/or population distribution of different shapes may be used to enhance the game played simultaneously with consumption of the product.

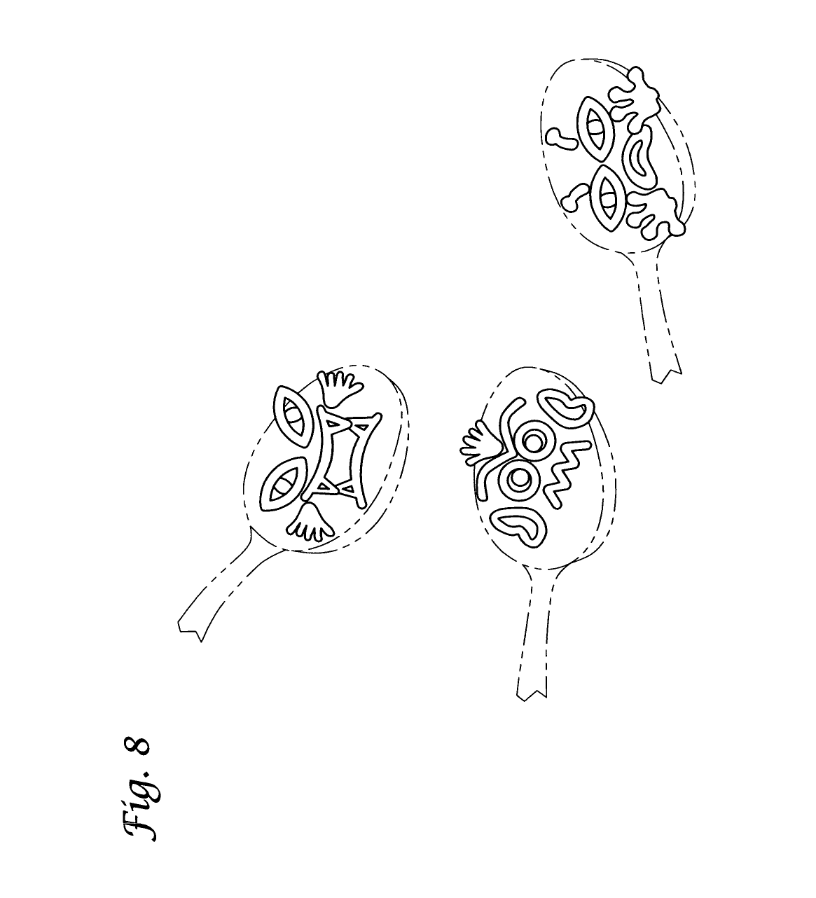

Exemplary embodiments of some edible novelty products are depicted in FIGS. 8-13, each of which is briefly described below.

FIG. 8 depicts an edible novelty product that includes a plurality of anatomical features such as eyes, ears, hair, mouths, hands, bones, arms, legs, trunks or torsos, heads, etc. that can be located in a soup or other liquid for selection either randomly or intentionally by a consumer. The selection of edible articles may provide the parts to allow a consumer to form a face, dinosaur, skeleton, robot, person, etc.

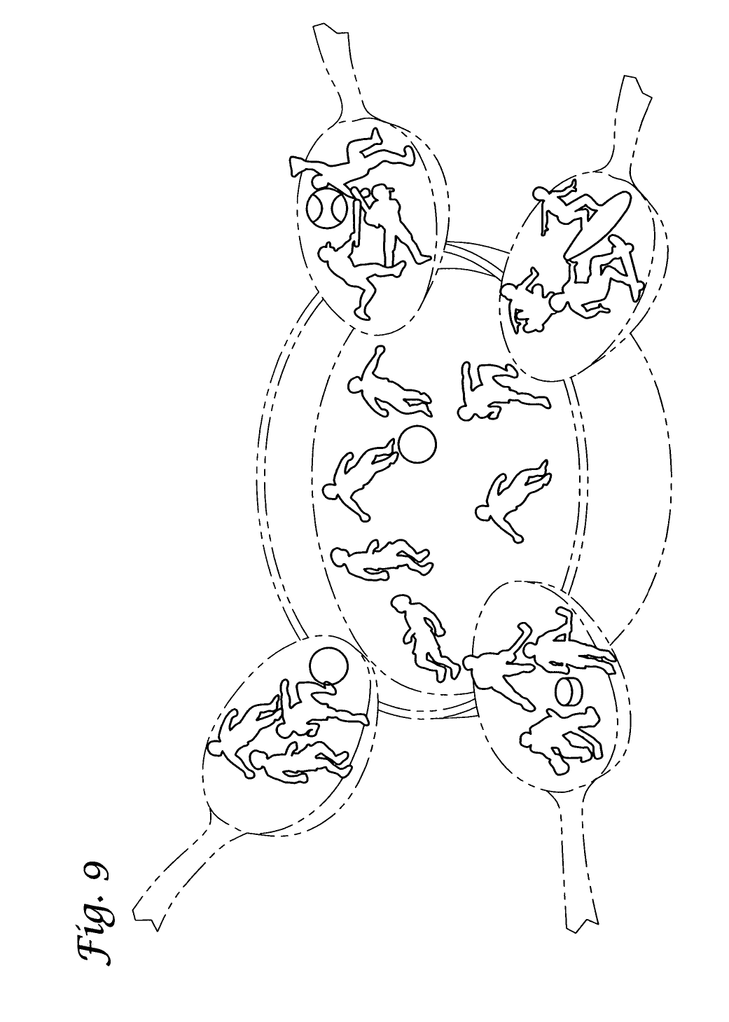

FIG. 9 depicts an edible novelty product that includes a plurality of edible articles in the shapes of sports figures for any sport. The edible objects may preferably be located in a liquid medium. Those sports specifically depicted in FIG. 9 include, e.g., hockey, soccer, baseball, skate/surf boarding, etc.

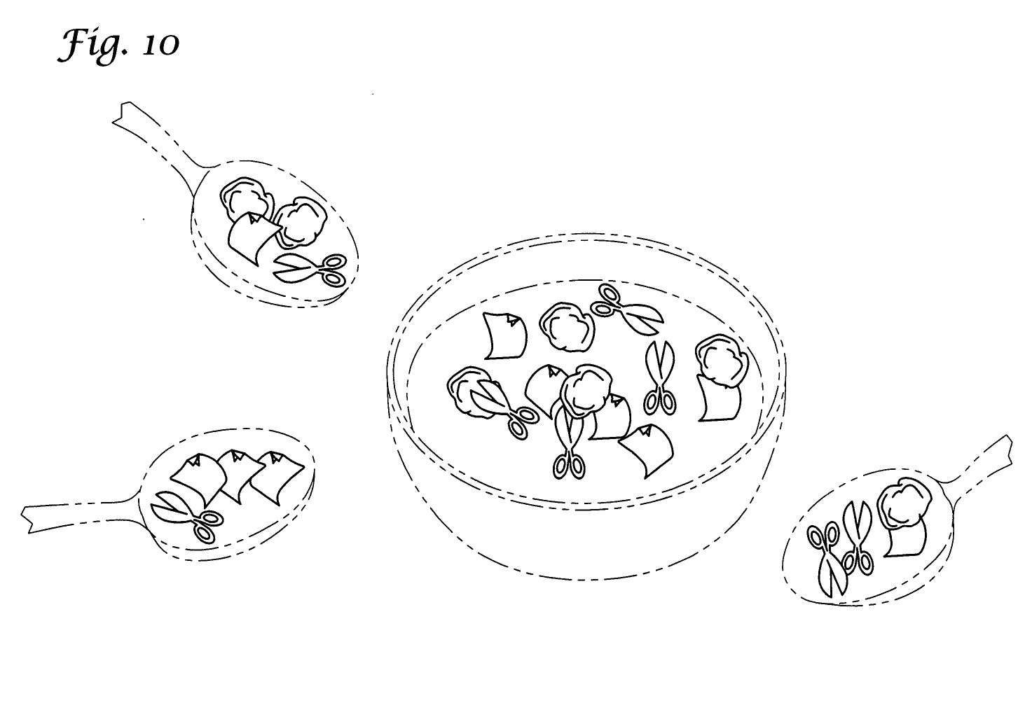

FIG. 10 depicts an edible novelty product that includes a plurality of edible articles that resemble a rock, paper, and scissors to allow a consumer to play the game rock-paper-scissors by selecting edible articles from the soup using an eating utensil.

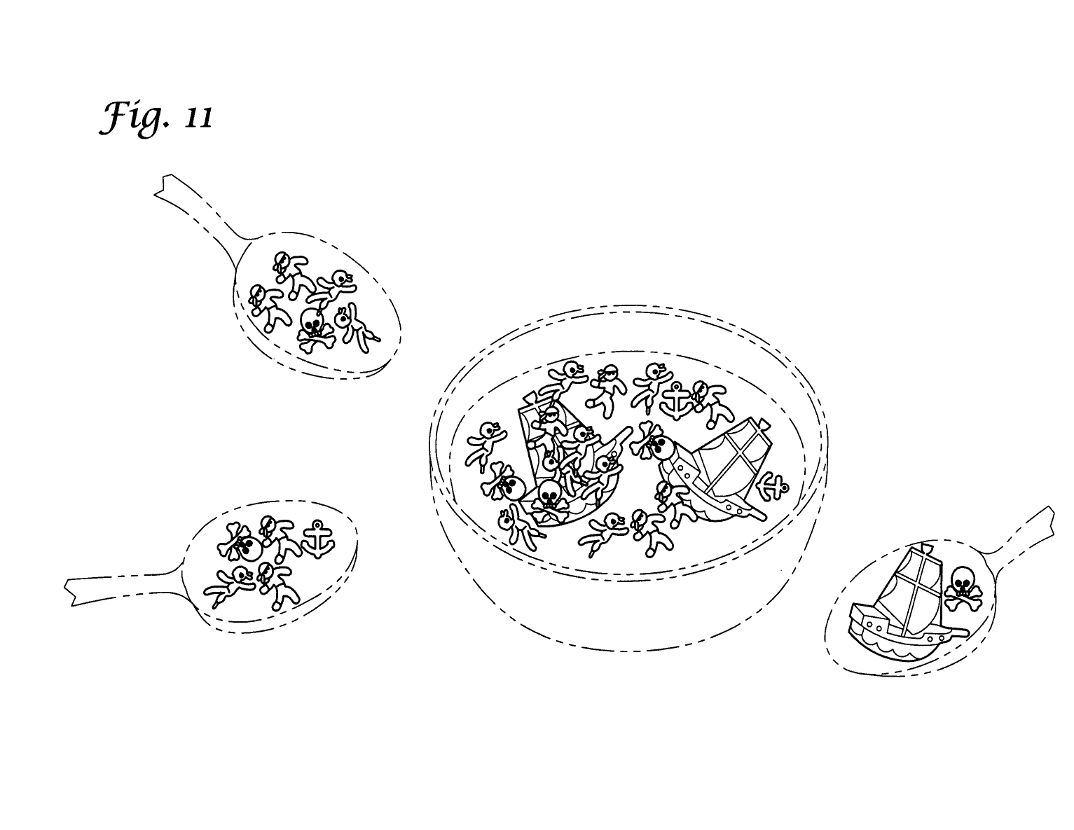

FIG. 11 depicts an edible novelty product that includes a plurality of edible articles in the shape of pirates, pirate icons (e.g., skull & crossbones), and a ship in a soup broth or other liquid medium. On object of such an activity may be, e.g., to place pirate figures on the ship until the ship sinks into the soup broth. In such a game, the edible articles may be supplied separately from the soup broth as, e.g., crackers or other dry goods or they may be supplied in the soup broth in hydrated form. Alternatively, the ships may be supplied as crackers or other dry goods, while the pirates and other objects may be supplied as, e.g., noodles within the soup.

Another variation involves an edible novelty product including one or more edible articles with a recess that may float in a liquid. For example, a noodle floating in soup broth, cereal pieces floating in a bowl or cup of milk, cookies or marshmallows floating in a cup of hot chocolate, etc. The floating edible articles may preferably have a recess that would allow them to be filled with a liquid that would cause the piece to tip over and sink. The game could be played by trying to tip or sink as many pieces as possible by skillfully filling each piece with liquid and/or other edible articles using a spoon, straw or other eating utensil.

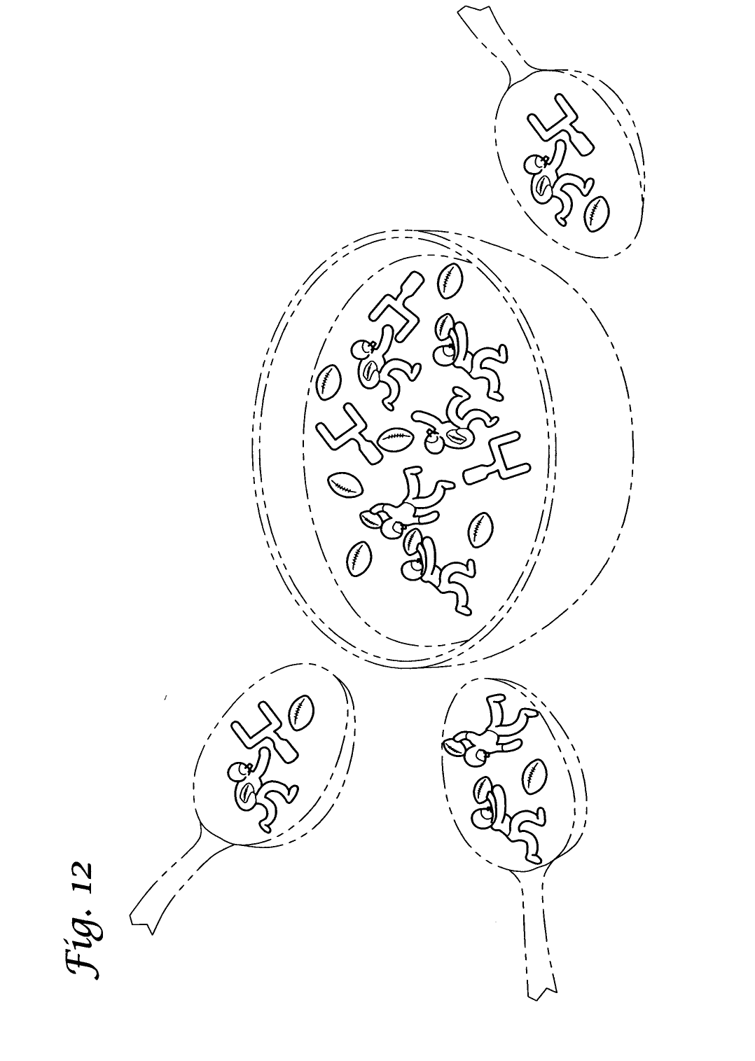

FIG. 12 depicts an edible novelty product that includes a plurality of edible articles in the shape of football players, goalposts, and footballs. An activity that may be associated with such a product may include, e.g., selecting spoonfuls of soup containing at least one of each edible article. Analogous activities may be envisioned for other sports in which a player and articles associated with scoring may be included in the edible novelty product. Examples may include, but are not limited to, hockey (using a hockey player, goal, and hockey puck), basketball (using a player, hoop, and basketball), baseball, (using a player, bat, and ball), soccer, (using a player, goal, and soccer ball), etc.

Another embodiment of the invention may combine edible articles in shapes and designs from more than one sport or game. The activity could include skill and knowledge of different sports. For example, the players (consumers) may be required to combine actions that simulate the play experience from two known sports in a simple game of skill and chance.

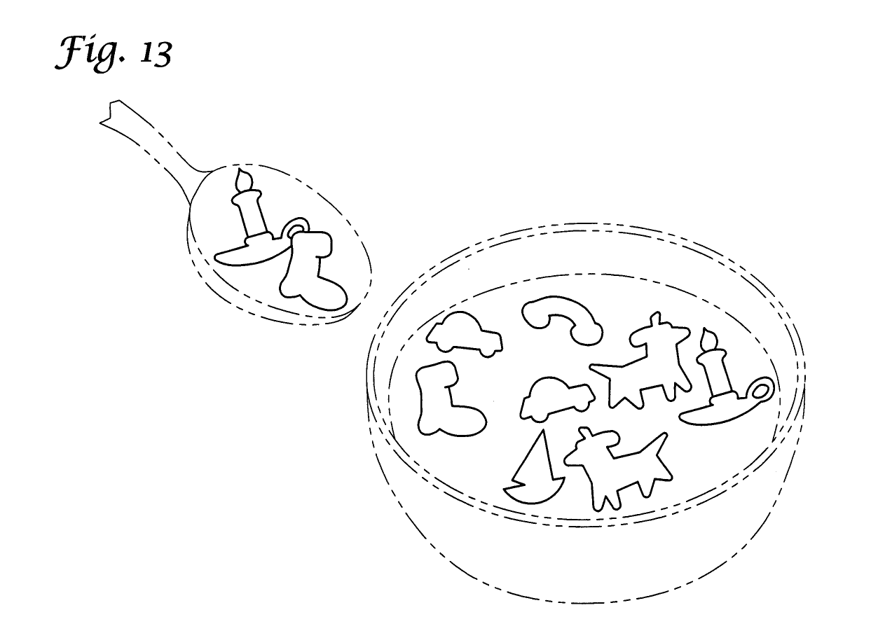

FIG. 13 depicts an edible novelty product that includes a plurality of edible articles in the shape of clues that lead one to solve a mystery in combination with instructions provided as a part of the product (on or in the container, for example).

As used herein and in the appended claims, the singular forms “a,” “and,” and “the” include plural referents unless explicitly limited to the singular form or the context clearly dictates otherwise.

All references and publications cited herein are expressly incorporated herein by reference in their entirety into this disclosure. Illustrative embodiments of this invention are discussed and reference has been made to possible variations within the scope of this invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. An edible novelty product comprising:
a container;
a plurality of edible linking articles located within the container, wherein each linking article of the plurality of identical linking articles comprises a linking feature such that two or more of the linking articles can be attached to each other, wherein the linking articles are constructed of food product material, and wherein the linking articles comprise shapes that are not alphabetical characters.

2. An edible novelty product according to claim 1, wherein substantially all of the edible linking articles in the container comprise at least one linking feature.

3. An edible novelty product according to claim 1, wherein the linking feature comprises a gap in an otherwise closed figure.

4. An edible novelty product according to claim 3, wherein the line figures are formed by food product material comprising a line width, and wherein the gap comprises an opening that is four times or less the line width.

5. An edible novelty product according to claim 3, wherein each linking article of the plurality of identical linking articles comprises a only one closed figure comprising the gap formed therein.

6. An edible novelty product according to claim 3, wherein each linking article of the plurality of identical linking articles consists essentially of a geometric figure that is closed except for the gap formed therein.

7. An edible novelty product according to claim 1, wherein each linking article of the plurality of identical linking articles comprises two or more linking features.

8. An edible novelty product according to claim 1, wherein each linking feature comprises two or more hooks extending outward from a central portion.

9. An edible novelty article according to claim 8, wherein the two or more hooks are arcuate in shape.

10. An edible novelty product according to claim 8, wherein at least two hooks of the two or more hooks open in opposite directions relative to each other.

11. An edible novelty product according to claim 1, wherein the linking feature on each of the linking articles comprises at least one of an interlocking male feature or an interlocking female feature such that at least two of the linking articles can be attached to each other using one interlocking male feature and a complementary interlocking female feature.

12. An edible novelty product according to claim 11, wherein the linking articles attached together using one of the interlocking male features and one of the interlocking female features form a composite animal-like shape.

13. An edible novelty product according to claim 11, wherein each linking article of the plurality of edible linking articles comprises a portion of an animal, and wherein portions of different animals can be connected to form a composite animal using the interlocking male linking feature on one linking article from one animal and the interlocking female feature on another linking article from a different animal.

14. An edible novelty product according to claim 1, wherein the plurality of linking articles consist essentially of digestible food product material.

15. An edible novelty product according to claim 1, further comprising instructions directing a consumer to link two or more of the linking articles of the plurality of linking articles together.

16. An edible novelty product according to claim 1, wherein the food product material comprises flour.

17. An edible novelty product according to claim 1, wherein the food product material comprises baked pretzel dough.

18. An edible novelty article according to claim 1, wherein the food product material comprises marshmallow.

19. An edible novelty product according to claim 1, further comprising liquid in the container, and wherein the plurality of linking articles comprise noodles.

20. An edible novelty product according to claim 1, further comprising dried soup broth or sauce powder in the container, and wherein the plurality of linking articles comprise noodles.

21. An edible novelty product according to claim 1, further comprising a dried beverage powder in the container.

22. An edible novelty product comprising:
a container;
a plurality of edible articles located within the container, wherein the edible articles are constructed of food product material, and wherein each edible article of the plurality of edible articles is in the shape of one or more words.

23. An edible novelty product according to claim 22, further comprising a dried soup broth or beverage powder in the container.

24. An edible novelty product according to claim 22, wherein the plurality of edible articles comprise a plurality of different word shapes.

25. An edible novelty product according to claim 22, wherein the plurality of edible articles comprise a plurality of different word shapes, and wherein the different word shapes comprise at least one noun and at least one verb.

26. An edible novelty product according to claim 22, wherein at least some of the edible articles comprise a shape in the form of two or more words arranged together.

27. An edible novelty product according to claim 22, wherein the plurality of edible articles consist essentially of digestible food product material.

28. An edible novelty product according to claim 22, wherein the food product material comprises flour.

29. An edible novelty product according to claim 22, wherein the food product material comprises baked pretzel dough.

30. An edible novelty article according to claim 22, wherein the food product material comprises marshmallow.

31. An edible novelty product according to claim 22, further comprising liquid in the container, and wherein the plurality of edible articles comprise noodles.

32. An edible novelty product according to claim 22, further comprising dried soup broth or sauce powder in the container, and wherein the plurality of edible articles comprise noodles.

33. An edible novelty product according to claim 22, further comprising a dried beverage powder in the container.

34. An edible novelty product comprising:
a container;
a dried soup broth, sauce, or beverage powder located in the container; and
a plurality of edible articles located within the container, wherein the edible articles are constructed of food product material, and wherein each edible article of the plurality of edible articles comprises indicia in the form of a word located on a surface of the edible novelty article.

35. An edible novelty product according to claim 34, wherein the indicia on the plurality of edible articles comprise two or more different words.

36. An edible novelty product according to claim 34, wherein the indicia on the plurality of edible articles comprise two or more different words, and wherein the different words comprise at least one noun and at least one verb.

37. An edible novelty product according to claim 34, wherein the indicia comprises two or more words arranged together on one edible article of the plurality of edible articles.

38. An edible novelty product according to claim 34, wherein the plurality of edible articles consist essentially of digestible food product material.

39. An edible novelty product according to claim 34, wherein the food product material comprises flour.

41. An edible novelty article according to claim 34, wherein the food product material comprises marshmallow.

42. An edible novelty product according to claim 34, wherein the plurality of edible novelty articles comprise noodles.

43. An edible novelty product comprising:
a container;
a liquid located in the container; and
a plurality of edible articles located within the liquid, wherein the edible articles are constructed of food product material, and wherein each edible article of the plurality of edible articles comprises indicia in the form of a word located on a surface of the edible novelty article.

44. An edible novelty product according to claim 43, wherein the indicia on the plurality of edible articles comprise two or more different words.

45. An edible novelty product according to claim 43, wherein the indicia on the plurality of edible articles comprise two or more different words, and wherein the different words comprise at least one noun and at least one verb.

46. An edible novelty product according to claim 43, wherein the indicia comprises two or more words arranged together on one edible article of the plurality of edible articles.

47. An edible novelty product according to claim 43, wherein the plurality of edible articles consist essentially of digestible food product material.

48. An edible novelty product according to claim 43, wherein the food product material comprises flour.

49. An edible novelty product according to claim 43, wherein the plurality of edible novelty articles comprise noodles.

50. An edible novelty product according to claim 43, wherein the liquid comprises soup broth or sauce.

51. An edible novelty product comprising:
an edible body comprising a cavity formed therein, wherein the edible body is constructed of food product material;
a gas producing edible composition located in the cavity, wherein the gas producing edible composition produces a gas when contacted with an aqueous solution.

52. An edible novelty product according to claim 51, wherein the gas producing edible composition comprises baking powder.

53. An edible novelty product according to claim 51, wherein the food product material comprises a baked food product.

54 An edible novelty product according to claim 51, wherein the edible body is in the shape of a submarine.
